(19) United States
(12) Patent Application Publication
(10) Pub. No.: US 2014/0216358 A1
(43) Pub. Date: Aug. 7, 2014

(54) SURFACE FRICTION PET PUZZLE TOY

(71) Applicant: Kyle Hansen, Castle Rock, CO (US)

(72) Inventor: Kyle Hansen, Castle Rock, CO (US)

(21) Appl. No.: 13/759,940

(22) Filed: Feb. 5, 2013

(51) Int. Cl. A01K 15/02

(52) U.S. Cl. CPC A01K 15/025
USPC 119/707

(57) ABSTRACT

The invention relates to a novel pet toy in which a ball slides across a surface via cutouts in the base of the toy and uses friction to assist with the sliding motion. The toy is especially effective on carpeted surfaces. A transparent top piece allows the pet to see the ball inside move and thus is enticed to retrieve the moving ball. Four arms of the toy emanate from the center and provide one or more exit apertures for a pet to determine how to, and then retrieve the ball.

### FIELD

The invention relates to a novel pet toy in which a ball slides across a surface via cutouts in the base of the toy and uses friction to assist with the sliding motion. Four arms of the toy provide one or more exit apertures for a pet to determine how to, and then retrieve the ball.

### BACKGROUND OF THE INVENTION

The invention most closely corresponds with USPTO Class 119/702 wherein Class 119 relates to animal husbandry and sub-class 702 includes exercise or amusement devices for animals.

In its simplest form, the invention comprises a novel pet toy wherein a ball is inserted into the toy and the pet must determine how to slide the toy in such a ways as to access the ball inserted.

It is well known in the animal behavior sciences that is a dog doesn't get the mental stimulation it needs it will develop Behavior problems such as chewing, biting or elimination in the home due to boredom, stress or depression. Veterinary science has also determined that in addition to behavioral problems, a dog will also be more prone to diseases as the immune system can weaken due to stress or depression. Thus it is imperative to challenge a dog with activities such as the inventive toy presents.

### THE INVENTION

### Summary, Objects and Advantages

All who studied any form of psychology in school remember Pavlov's Dogs. A simple conditioning test resulted in dogs remembering or being cognitive of being given a reward when a bell was rung. Thus the dogs would respond in various cognitive ways when a bell was rung. This behavior presented itself for months after the actual tests were ceased. Pavlov evidenced that dogs actually had memory and the ability to react to certain stimuli on a consistent basis.

In the inventive toy, there is a base piece, a mirror affixed top piece, and four arms or branches which emanate out from the center of the toy. The base contains a cutout channel in each of the arms wherein the ball contacts the surface of a floor and this assists in sliding by using friction naturally associated with the ball rolling along the surface of the floor. This toy is especially applicable to carpeted floors where most toys will not slide across such a surface.

The cutout channels will allow the ball to slide to and fro within the toy as the pet pushes the toy across a surface. The top piece of the toy is transparent so as to allow the pet to see the ball moving within, and entice them to attempt to retrieve the ball. One or more of the arms contains an end cap which will either cover or expose the opening end of the arm so that the inserted ball may be inserted or removed.

When the pet slides the toy across a surface, the inserted ball will naturally roll within the cutout channels. This motion will also use friction to aid in the entire toy sliding across a surface such as a carpeted floor. A specific amount of force must be used to cause the ball to jump the edge of the channel and exit through one of the arm end apertures. The pet must learn how to maneuver the ball into one of the toy arms and apply the proper force to get the ball to exit an unobstructed arm opening.

The friction reacting toy works efficiently on a carpeted surface, but will also work on a hard surface such as a wood or linoleum floor without damaging said surface.

### BRIEF DESCRIPTION OF THE DRAWINGS

The invention is described in further detail by reference to three drawings sufficient in detail to describe the invention in which:

FIG. 1 is a perspective of the toy showing the transparent top, ball and four apertures;

FIG. 2 is a top view of the toy showing the ball as centered within the channels and one arm end cap removed; and

FIG. 3 is a bottom view of the toy's base, channels, and the ball as centered within the channels.

### DETAILED DESCRIPTION, INCLUDING BEST MODES OF CARRYING OUT THE INVENTION

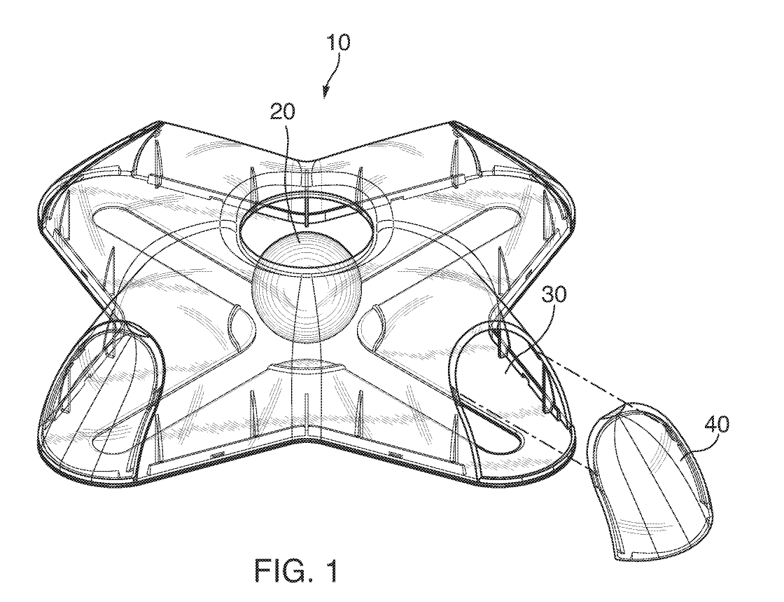

FIG. 1 is shows the puzzle toy 10 as embodied with a transparent top piece. The ball 20 is shown as inserted therein via one of the arm apertures 30. The end cap of the arm 40 is removed so that a pet owner can insert the ball, and the pet then must learn how to access the ball. One or more arm end caps may be removed to vary the challenge and skill set of the pet.

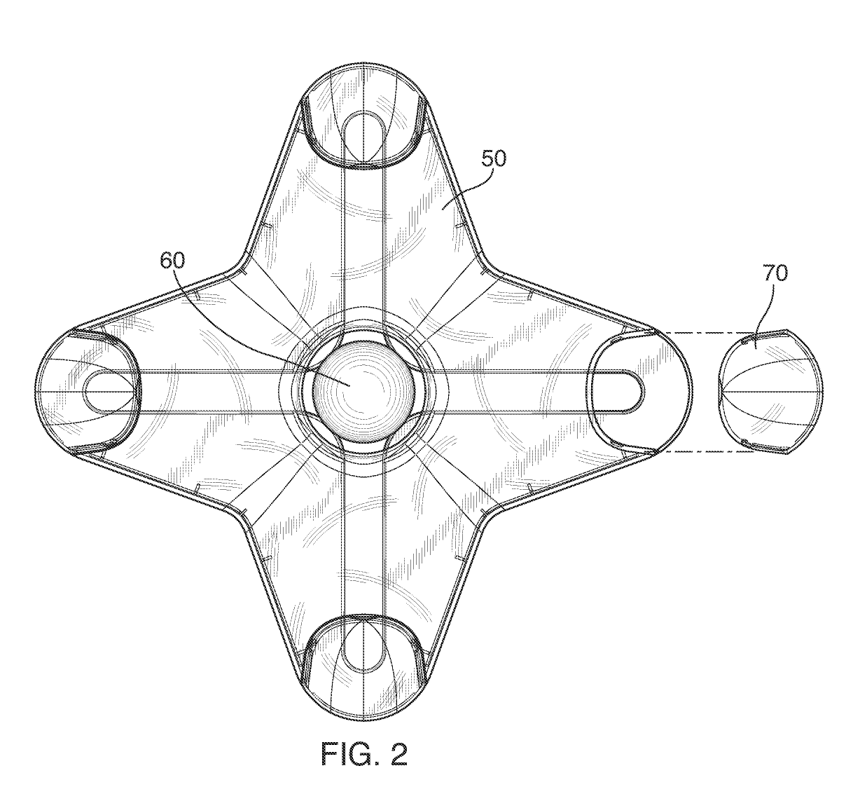

FIG. 2 illustrates the toy as viewed from above 50. Again the transparent top piece allows the pet to view the ball 50 within as it travels to and fro along the channels. The arm end cap 70 is removable for insertion and extraction of the ball.

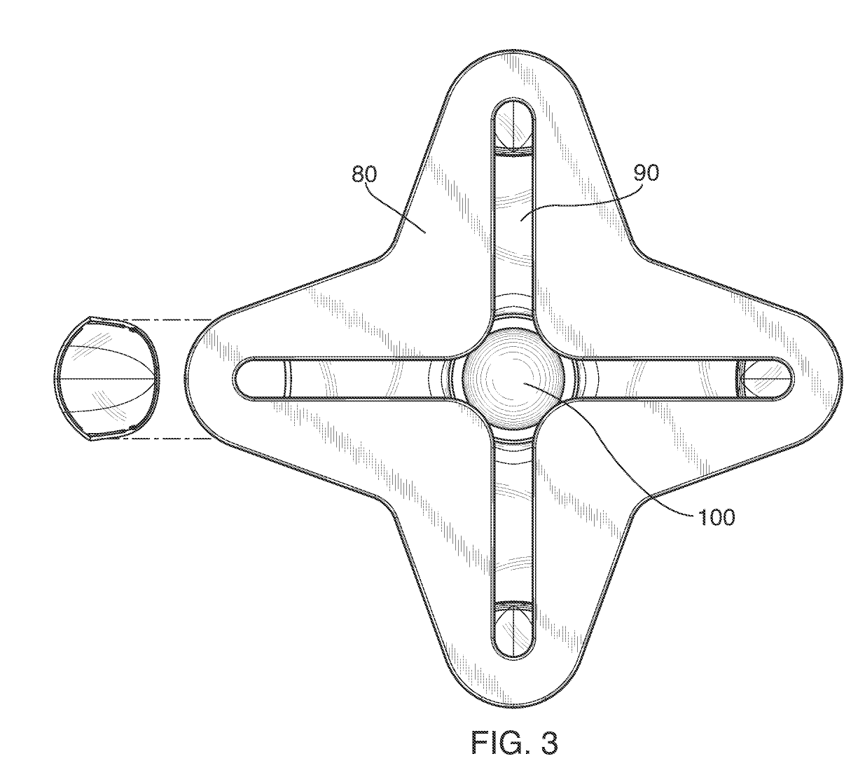

FIG. 3 is a view of the base or underside of the toy 80. This may be colored or also transparent. The channels 90 allow the ball 100 to slide and roll across a surface using simple friction and remaining within the channels until the pet learns to exert enough force to get the ball to eject from the opened end cap 110.

1. A surface friction pet toy comprising;
a) a base piece
b) a transparent top piece
c) cutout channels in the base piece
d) arm end apertures or openings
e) arm end caps

2. A surface friction pet toy as in claim 1 wherein the base piece has four arms or branches extruding from the center.

3. A surface friction pet toy as in claim 1 wherein a transparent top piece mirrors and is affixed to the base piece.

4. A surface friction pet toy as in claim 1 wherein four cutout channels are machined out of the base piece to allow contact of inserted items with a floor surface.

5. A surface friction pet toy as in claim 1 wherein the four arms emanating from the center have an opening or aperture at the end thereof.

6. A surface friction pet toy as in claim 1 wherein the four arms have an end cap which is removable and will expose or obstruct the arm openings.
